(19) United States
(12) Patent Application Publication
(10) Pub. No.: US 2019/0314885 A1
(43) Pub. Date: Oct. 17, 2019

(54) APPARATUS AND METHOD FOR TWISTING FIRST AND SECOND SINGLE ELECTRICAL WIRES TO FORM A CABLE PAIR

(71) Applicant: komax Holding AG, Dierikon (CH)

(72) Inventors: Dominik STAUBLI, Horw (CH); Denis FACCENDA, Altdorf (CH)

(73) Assignee: komax Holding AG, Dierikon (CH)

(21) Appl. No.: 16/373,858

(22) Filed: Apr. 3, 2019

(30) Foreign Application Priority Data
Apr. 17, 2018 (EP) 18167774.1

(51) Int. Cl. B21F 7/00; H01B 13/00

(52) U.S. Cl. CPC B21F 7/00; H01B 13/0036

(57) ABSTRACT

An apparatus and a method twists first and second single electrical wires to form a cable pair. The apparatus includes a main twisting device and a retwisting device with an stationary retwisting module and a retwisting module that is movable along a linear guide direction. Each of the retwisting modules also includes a transfer unit for transferring and holding an end of the twisted cable pair, wherein the transfer unit includes a first wire gripper for the first single electrical wire and a second wire gripper for the second single electrical wire, wherein a relative distance between the first wire gripper and the second wire gripper can be changed, typically programmably changed, according to a distance between the ends of the wires. At least one of the stationary retwisting module and the movable retwisting module is configured for the retwisting of the respective held cable pair.

### CROSS REFERENCE TO RELATED APPLICATIONS

Applicant claims priority under 35 U.S.C. § 119 of European Application No. 18167774.1 filed Apr. 17, 2018, the disclosure of which is incorporated by reference.

### BACKGROUND OF THE INVENTION

### 1. Field of the Invention

The present disclosure relates to an apparatus for twisting first and second single electrical wires to form a cable pair, and a method for twisting first and second single electrical wires to form a cable pair using an apparatus described herein.

### 2. Description of the Related Art

In certain applications, two single electrical wires which are guided side by side are twisted in wire processing apparatuses. After twisting, the wires form a (twisted) cable pair, which is guided for example into a connector housing in a subsequent step.

Document EP 1 032 095 B1 describes a conventional wire processing apparatus with an automatic twister. Two single electrical wires are drawn in simultaneously and prepared. Preparation typically includes that at least at one end of the individual wires is cut to length, insulated and/or fitted with contacts, grommets etc. After the leading wire ends have been prepared, the single electrical wires are drawn out; the trailing ends are then prepared; and then the wires are transferred to the actual twisting apparatus. This includes a stationary holding module which holds the trailing wire ends during twisting, and a twisting head which is movable in the direction of the cable and grips the leading wire ends and turns (twists) them together. During twisting, the cable pair becomes shorter as a result of the intertwining of the single electrical wires. A tensile force is measured and the twisting head is shifted under feedback control according to the measured tensile force, so that due account is taken of the shortening effect.

Document EP 3 012 841 A1 describes an apparatus for feeding wire ends to an apparatus for further processing. In this case, wires are held a small distance apart and twisted. Both wire ends are held by a single pair of gripper jaws.

The method known from EP 3 012 841 A1 makes it more difficult to transmit tensile forces that are generated during twisting to the single electrical wires. A clamping force applied to the single electrical wires by the pair of gripper jaws can only be increased by a limited degree to ensure a secure retaining without damaging, for example deforming, the single electrical wires, which, as a consequence, would reduce the quality of the cable pair.

### SUMMARY OF THE INVENTION

It is an object of the present disclosure to provide an apparatus or a method for twisting first and second single electrical wires to form a cable pair which ensures a high quality of the twisted cable pair.

These and other objects are achieved by an apparatus for twisting first and second single electrical wires to form a cable pair according to the invention.

According to one aspect, the apparatus comprises a main twisting device and a retwisting device having one retwisting module which is stationary and one retwisting module which is displaceable along a linear guide direction. Each of the retwisting modules comprises a transfer unit for transferring and holding an end of the twisted cable pair, wherein the transfer unit comprises a first wire gripper for the first single electrical wire and a second wire gripper for the second single electrical wire, a relative distance between the first wire gripper and the second wire gripper may be altered according to a distance between the wire ends. At least one of the stationary retwisting module and the movable retwisting module is configured for retwisting of the cable pair which is held in each case.

In this context, “retwisting”, “retwisting device” and so on designate aspects which are subsequent in time to a main twisting subprocess in the course of a complete twisting operation to form a cable pair. A main twisting process is carried out for example similarly to the twisting operation described in EP 1 032 095 B1. Following the main twisting process, the single electrical wires in the cable pair are in an intertwined state over most of the length of the cable pair. However, the respective wire ends of the cable pair (typically both the leading wire ends and the trailing wire ends) are farther apart from each other.

According to the present disclosure, the transfer unit takes over one end of the twisted cable pair and holds it. The first wire gripper of the transfer unit holds the first single electrical wire, and the second wire gripper holds the second single electrical wire. The distance between the first wire gripper and the second wire gripper may be changed corresponding to the distance between the ends of the single electrical wires. The distance between the first wire gripper and the second wire gripper is typically reduced, with the result that the distance between the ends of the single electrical wires is also reduced correspondingly.

Then, having been brought closer to one another the ends of the single electrical wires undergo retwisting. The retwisted ends of the wires in the twisted cable pair which has undergone retwisting are of high quality and closer together.

The distance between the first wire gripper and the second wire gripper can typically be changed by programming. Programmable change comprises, for example, adjusting the distance between the first wire gripper and the second wire gripper according to a predefined or predefinable wire configuration (specification of a distance of a first crossing position, lay length of the twist etc.) and/or according to a make-up of the wire (wire cross-section, insulation thickness etc.).

In certain embodiments, the first and/or second wire gripper is/are configured for fixing the respective held single electrical wire. Alternatively, at least one of the stationary or movable retwisting modules comprises a fixing device which is configured for fixing the respective held single electrical wire. As used herein, the term fixing includes holding for preparing and/or for carrying out the retwisting operation.

In certain embodiments, at least one of the stationary or movable retwisting modules comprises a retwisting head. Each retwisting head holds the two single electrical wires of the twisted cable pair and performs a predefined or predefinable, typically programmable number of revolutions for the retwisting.

In certain embodiments, at least one of the retwisting heads is movable in the extension direction of the cable pair, so that a tensile force is applied to the cable pair. With the application of a tensile force, wire parameters such as the lay length may also be assured to the secondary twisted wire section at the wire end. The at least one of retwisting heads may be constructed so as to be movable with feedback-controlled force to apply a predefined or predefinable tensile force to the cable pair.

In certain embodiments, the movable retwisting module is constructed as a carriage, which is provided on a linear guide of the device and movable in guided manner along the linear guide in the linear guide direction. A design in the form of a carriage with linear guidance enables a particularly simple and effective construction. The carriage may be movable by means of a toothed belt drive, which simplifies the construction further.

In certain embodiments, the movable retwisting module further comprises a drive unit for moving the respective held ends of the wires in the direction of the wire. The drive unit is typically embodied as a spindle drive.

In certain embodiments, the transfer unit further comprises a horizontal drive unit and a vertical drive unit, wherein the horizontal drive unit and the vertical drive unit are configured such that they move at least one of the first or second wire grippers vertically and horizontally in a plane aligned perpendicularly to the cable axis. The horizontal drive unit is a horizontal spindle drive, for example. The vertical drive unit is a vertical spindle drive, for example.

According to a further aspect, a method is presented for twisting a first and a second single electrical wire to form a cable pair using an apparatus as described herein. The method comprises twisting the single electrical wires with the main twisting module to obtain a twisted cable pair; moving the wire grippers of the transfer module to a position corresponding to an associated single electrical wire of the twisted cable pair; transferring the single electrical wires to the respectively associated wire grippers; reducing the distance between the wire grippers; bringing the twisted cable pair to a retwisting position; transferring the twisted cable pair to the retwisting heads of the retwisting modules; and performing retwisting of the twisted cable pair.

With this method, a retwisting process with a smaller distance between the single electrical wires at the ends of the cable pair may be automated. For example, the distance between the single electrical wires at one or both ends of the cable pair may be definable via a user interface. It is also conceivable that a distance of a first crossing position of the single electrical wires from the end of wire may be definable at the respective end. The first crossing position of the single electrical wires is the position, starting from the end under consideration, at which the wires touch and cross over each other for the first time to form the twisted state.

In certain embodiments, during the retwisting the twisted cable pair is fixed by one of the wire grippers or by a fixing gripper. This ensures a particularly simple and reliable retwisting.

In certain embodiments, the movable retwisting module is moved towards the stationary retwisting module before the twisted cable pair is brought to the retwisting position. The cable pair is thus slackened before it is brought into position. Slackening the cable pair reduces the risk of the held single electrical wires slipping out of the wire grippers or changing their position.

In certain embodiments, a tensile force is exerted on the cable pair that is to be twisted before the retwisting of the twisted cable pair and during the retwisting.

### BRIEF DESCRIPTION OF THE DRAWINGS

In the following section, embodiments of the disclosure are explained in greater detail with reference to the accompanying drawings. In the drawings:

FIG. 1 shows a twisted cable pair for illustrating the terms used herein;

FIG. 2 shows a further twisted cable pair for illustrating the terms used herein;

FIG. 3 shows a further twisted cable pair for illustrating the terms used herein;

FIG. 4 is a top view of a device for twisting first and second single electrical wires without a retwisting device for explaining the aspects disclosed herein;

FIG. 5 is a top view of a part of a device for twisting first and second single electrical wires with a retwisting device;

FIG. 6 shows a part of the apparatus 100 in an oblique view from below;

FIG. 7 is a perspective view of the movable retwisting module from a first direction;

FIG. 8 is a perspective view of the movable retwisting module from a second direction;

FIG. 9 is a perspective view of the stationary retwisting module 170 from a first direction;

FIG. 10 is a perspective view of the stationary retwisting module 170 from a second direction;

FIG. 11 is a combined view of an apparatus described herein while a method described herein is carried out;

FIG. 12 is a combined view of an apparatus described herein while a method described herein is carried out;

FIG. 13 is a combined view of an apparatus described herein while a method described herein is carried out;

FIG. 14 is a combined view of an apparatus described herein while a method described herein is carried out;

FIG. 15 is a combined view of an apparatus described herein while a method described herein is carried out;

FIG. 16 shows enlarged insets from the views in FIGS. 13-15;

FIG. 17 is a combined view of an apparatus described herein while a method described herein is carried out;

FIG. 18 is a combined view of an apparatus described herein while a method described herein is carried out;

FIG. 19 is a combined view of an apparatus described herein while a method described herein is carried out; and

FIG. 20 is a combined view of an apparatus described herein while a method described herein is carried out.

### DETAILED DESCRIPTION OF PREFERRED EMBODIMENTS

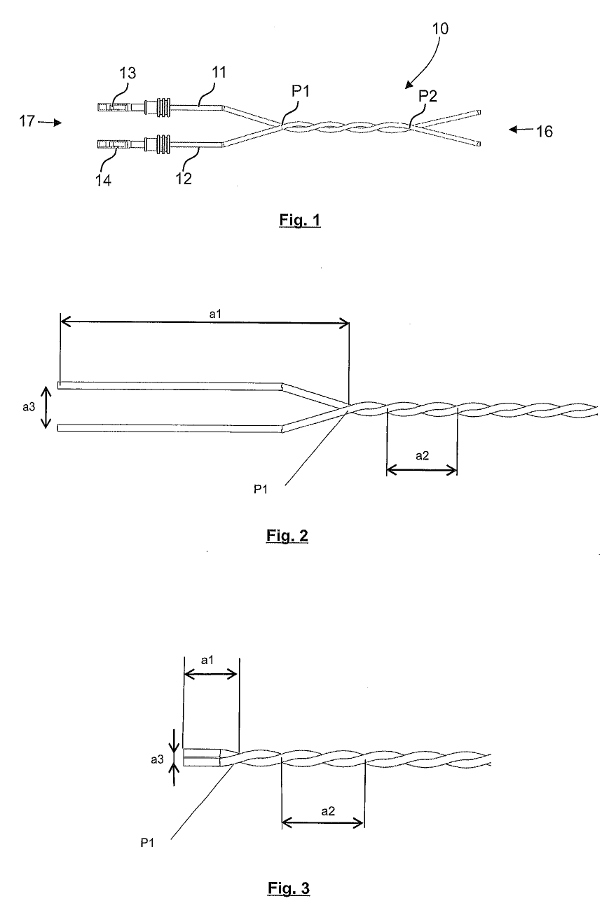

FIG. 1 shows a twisted cable pair 10 consisting of a first single electrical wire 11 and a second single electrical wire 12. One end 16 of the cable pair 10 is defined as the leading end, and is guided in an apparatus 100 for twisting as will be described later. The other end 17 of the cable pair is defined as the trailing end.

A first contact 13 and a second contact 14 are attached to the training end 17 of each of the wires 11 and 12. An area between the ends 16, 17 is twisted, i.e. the wires 11, 12 are wound around one another. Starting from the leading end 16 the wires 11, 12 intersect or cross over each other for the first time at a first crossing point P2. Similarly, the wires 11, 12 intersect or cross over each other starting from the training end 17 for the first time at a first crossing point P1.

For explanatory purposes, a partial area of the cable pair 10 is shown again in FIG. 2. The untwisted ends at the trailing ends of the single electrical wires 11, 12 have a length a1. The distance between two identical crossings or intersections of the wires 11, 12 in the twisted area is specified as the lay length a2.

Distance a3 is defined in a direction which is substantially perpendicular to the alignment direction of the cable pair 10 in which distances a1, a2 are defined. Distance a3 indicates the distance between the single electrical wires 11, 12 at the respective end, in FIG. 2 at the trailing end 17. A corresponding distance a3 is also defined at the leading end 16, and may be the same as or different from the distance a3 at the trailing end.

FIG. 3 shows the partial area of the wire pair 10 of FIG. 2. In FIG. 3, the distance a3 between the single electrical wires 11, 12 is smaller than in FIG. 2.

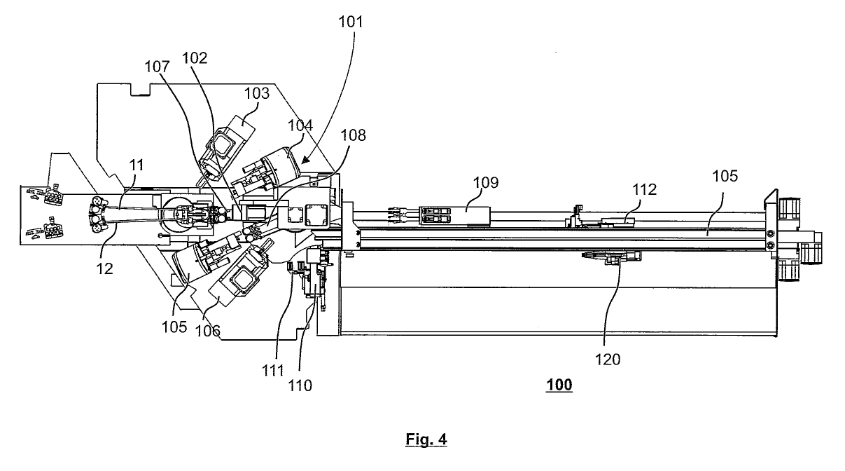

FIG. 4 represents an apparatus 100 for twisting the single electrical wires 11, 12 without a retwisting device for explanatory purposes.

In FIG. 4, the leading ends 16 of the single electrical wires 11, 12 are guided into a processing region 101, from where they can be guided further along a guide rail 105 along a machine axis. Processing modules 103, 104, 105, 106 are able to carry out manipulations on the wires 11, 12 in the processing region 101.

The leading ends of the single electrical wires 11, 12 are stripped or dismantled by a cutting head 102 and consecutively to processing modules 103, 104 on the one side with a first swivel unit 107. Here for example a grommet and a contact may be assembled on the wire end.

Then, the first swivel unit 107 brings the cable pair 10 back into alignment with the machine axis. There, the single electrical wires 11, 12 thereof are passed through until they can be gripped by an extracting carriage 109. The single electrical wires 11, 12 are drawn out according to the desired wire length by the extracting carriage 109 along the guide rail 105 in the direction defined by the linear guide.

The single electrical wires 11, 12 are then gripped by a second swivel unit 108 and severed and isolated by the cutting head 102. The trailing wire ends are fed to the processing modules 105, 106 on the other side by the second swivel unit 108 and assembly is completed, i.e. each is furnished with a grommet and a contact again, for example.

A transfer module 111 takes over the trailing end 17 of the single electrical wires 11, 12, brings them closer together and transfers them after a swivelling motion to a holding module 110. A transfer module 112 transfers the leading end 16 of the single electrical wires 11, 12 to a twisting head 120. The twisting head 120 is rotated in the apparatus 100 as shown in FIG. 4, wherein at the same time it is moved with a feedback-controlled tensile force in the direction of the holding module 110. The twisting head 120 forms a main twisting device, with which for example the cable pair shown in FIG. 2 may be obtained, having a comparatively large distance a3 between the respective ends 16 and 17 of the single electrical wires 11, 12.

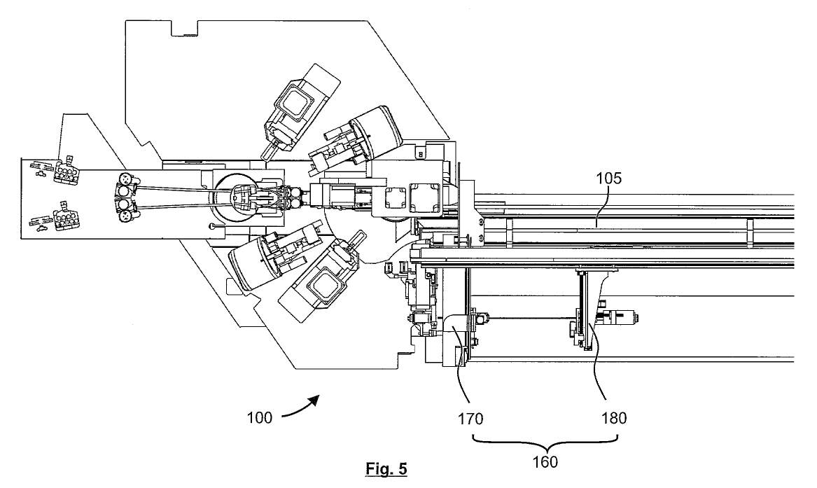

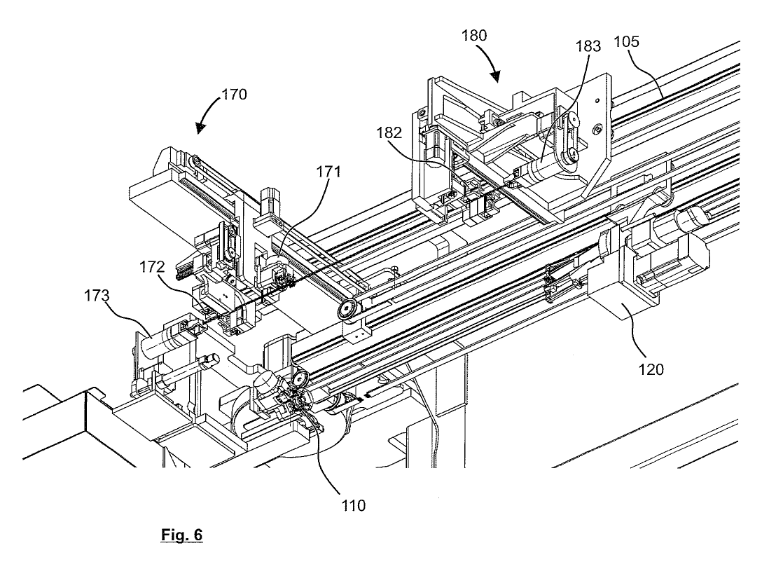

FIG. 5 shows a partial cross-sectional view of the apparatus 100 of FIG. 4, wherein a retwisting device 160 is also provided. The retwisting device 160 comprises a stationary retwisting module 170 and a movable retwisting module 180. The movable retwisting module 180 is movable along a linear guide which is provided separately on the guide rail 105, and which defines the linear guide direction for the movable retwisting module 180. The linear guide direction is aligned parallel to the direction of movement of the twisting head 120 and the extracting carriage 109.

FIG. 6 shows a part of the apparatus 100 in an oblique view from below. FIG. 6 shows examples of the holding module 110 and the twisting head 120. Instead of the holding module 110, it is also conceivable to provide a further twisting head in addition to twisting head 120.

The stationary retwisting module 170 has a retwisting head 173 and a transfer unit 172. Similarly, the movable retwisting module 180 has a retwisting head 183 and a transfer unit 182. In the embodiment represented in FIG. 6, the stationary retwisting module 170 also has a fixing gripper 171. The movable retwisting module 180 may have a corresponding fixing gripper (not shown).

The transfer units 172, 182 are configured in such manner that they take up the twisted cable pair 10 which has been twisted by twisting head 120 and transfer it to the respective retwisting head 173 or 183. If provided, the fixing grippers 171, 181, hold the cable pair 10 firmly during the retwisting operation.

The movable retwisting module 180 is embodied as a carriage which is displaceable on the linear guide 105 by a toothed belt drive (not shown). In this way, the twisting head 120 may be moved to various end positions depending on the twisted cable.

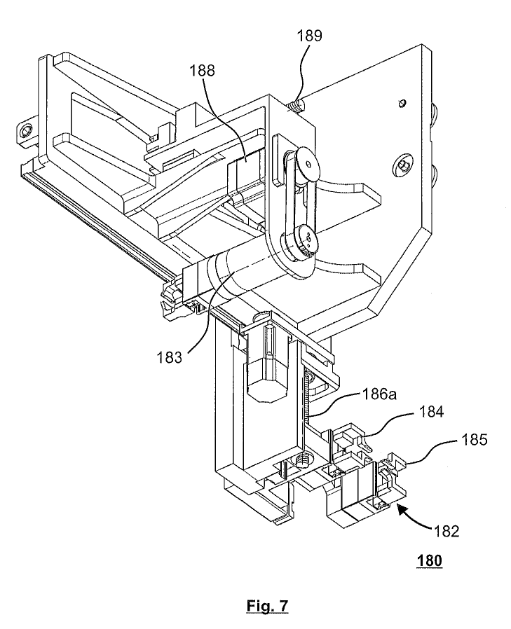

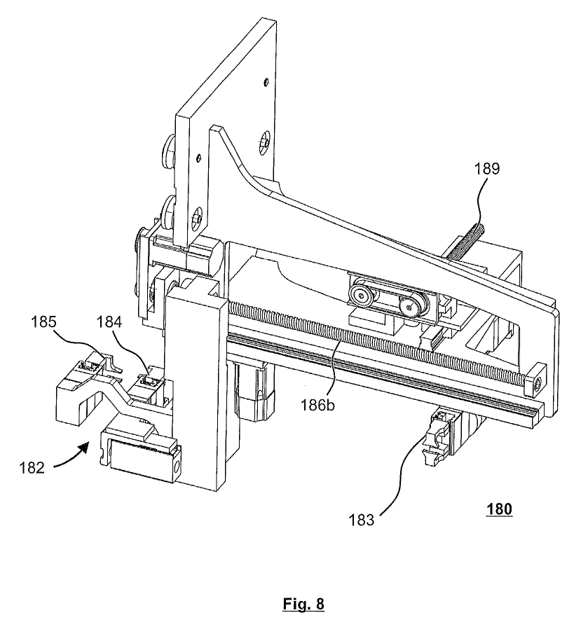

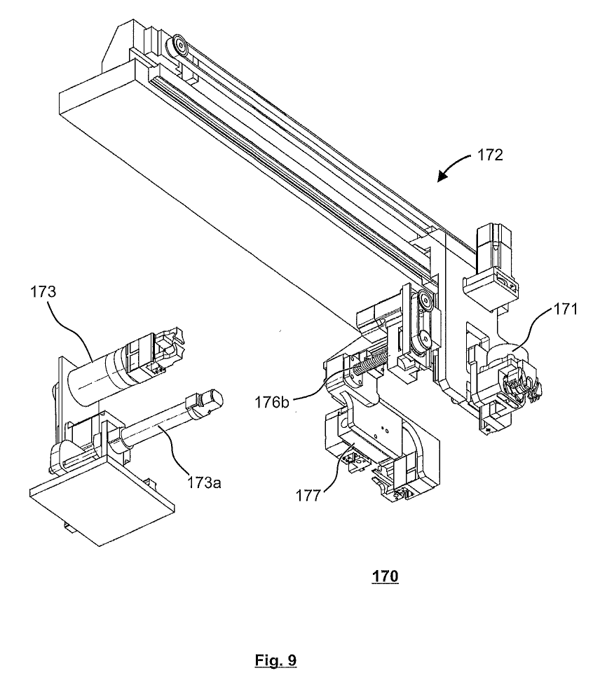

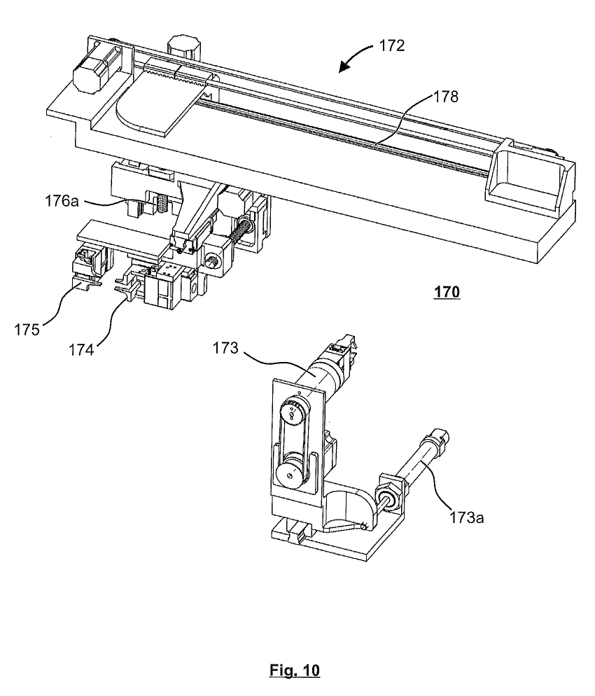

FIG. 7 shows a perspective view of the movable retwisting module 180 from a first direction, FIG. 8 shows it from a second direction. The retwisting head 183 is movable with a twisting motor 188 via a toothed belt drive. Additionally, the retwisting head 183 is movable in the direction of the cable via a first spindle drive 189. The transfer unit 182 supports a first wire gripper 184 and a second wire gripper 185, which serve to grip the ends of the single electrical wires 11, 12 which are at a considerable distance a3 from each other. One of the wire grippers 183, 185 is fastened to a linear axis, so that the distance between the two wire grippers may be varied programmably. The linear axis may be embodied as a servo-axis.

The transfer unit 182 has a horizontal spindle drive 186b and a vertical spindle drive 186a. The wire grippers 184, 185 may thus be moved vertically and horizontally in a plane perpendicular to the axis of the cable. Other variants besides the spindle drives with associated servomotors and guides are also conceivable for carrying out these movements, e.g., pistonless pneumatic cylinders.

FIG. 9 shows a perspective view of the stationary retwisting module 170 from a first direction, FIG. 10 shows it from a second direction. The stationary retwisting module 170 has the retwisting head 173 and the transfer unit 172. This module does not need to be moved; therefore, these components are not connected to one another and are fastened to the machine frame separately. The retwisting head 173 is constructed in similar manner to the retwisting head 183 and is movable in the direction of the twisted cable pair 10 by means of a pneumatic cylinder. The transfer unit 172 has a first wire gripper 174 and a second wire gripper 175, the distance between which may be altered with a linear axis 177.

The cable pair 10 may be fixed during the retwisting with a wire gripper 174, 175 or by a separately provided fixing gripper 171.

The transfer unit 172 has three axes of movement: a horizontal toothed belt drive 178 and a first vertical spindle drive 176a move the wire grippers 174, 175 and the fixing gripper 171 together in a plane perpendicular to the axis of the cable pair 10. A horizontal spindle drive 176b moves the wire grippers 174, 175 alone parallel to the axis of the cable pair 10.

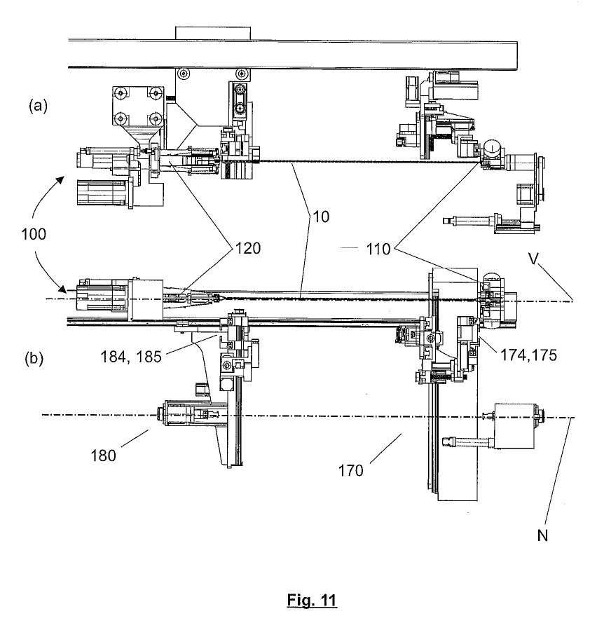

FIGS. 11 to 19 each show the apparatus 100 at different times while the method described herein is being carried out. Parts (a) of FIGS. 11 to 15, 17 to 20 in the upper section of each figure show a view in the direction from a twisting axis V towards a retwisting axis; parts (b) of FIGS. 11 to 15, 17 to 20 in the lower section of each figure show a view from below. Of course, the method flow described for exemplary purposes in FIGS. 11 to 20 can be modified if only one leading end 16 and trailing end 17 is to undergo retwisting by joining the wire ends and not performing retwisting of the end concerned.

FIG. 11 shows the starting situation. Components that are not identified with reference number in the following figures correspond to those in FIG. 11.

In FIG. 11, a cable pair 10 made from a first single electrical wire 11 and a second single electrical wire 12 that has been fully prepared and twisted with the twisting head 120 is held in the holding module 110. The distance a3 between the first single electrical wire 11 and the second single electrical wire 12 is comparatively large. The wire grippers 184, 185 of the movable retwisting modules 180 and the wire grippers 174, 175 of the stationary retwisting module 170 are in a waiting position above and between the twisting axis V and the retwisting axis N.

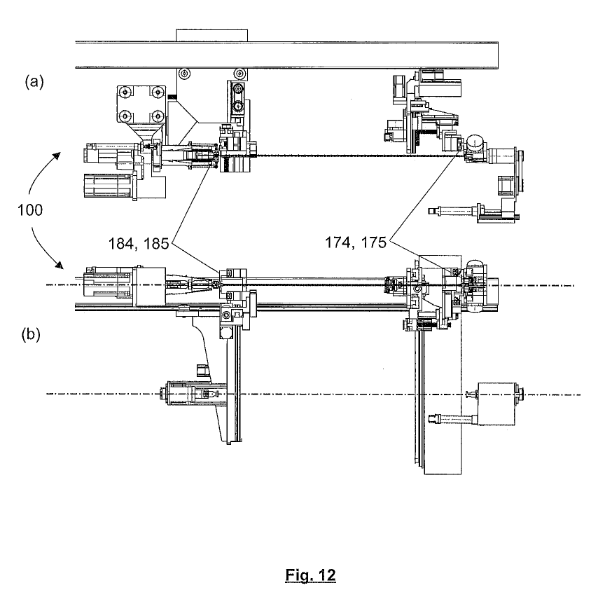

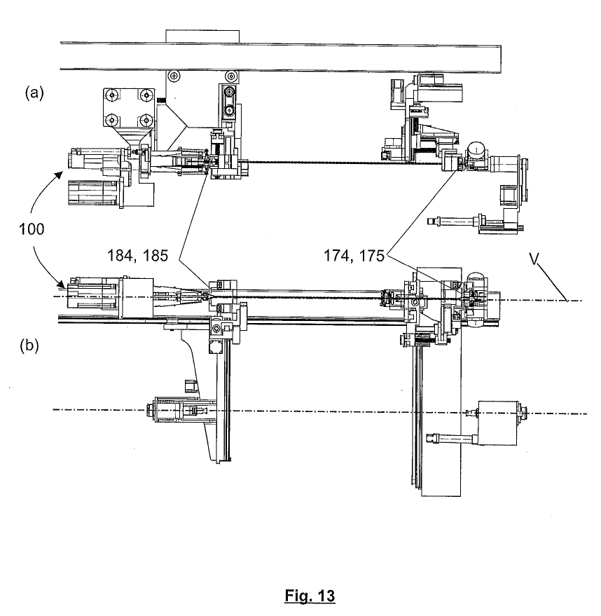

In the first step as shown in FIG. 12, the two wire gripper pairs 174, 175; 184, 185 are displaced horizontally until they are positioned above the respective wire ends. The wire grippers 174, 175; 184, 185 may be moved to their respective positions in the direction of the cable consecutively or simultaneously.

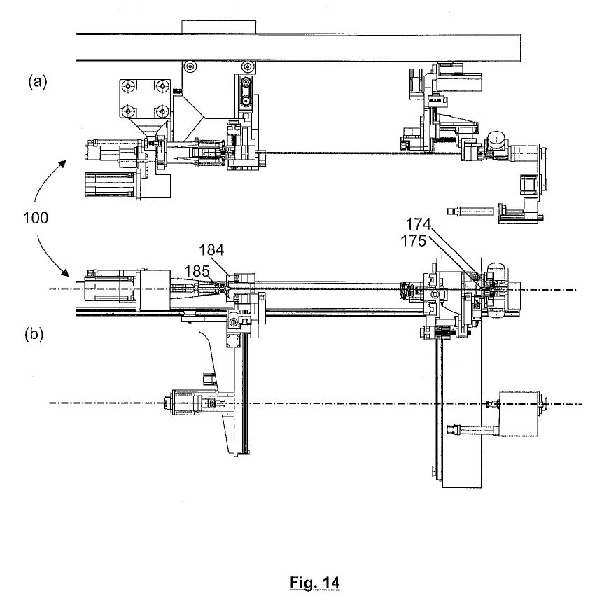

In the next step, as shown in FIG. 13, the wire gripper pairs 174, 175; 184, 185 are lowered and are then positioned level with the twisting axis V.

In the step shown in FIG. 14, the distance between the wire gripper 174 and wire gripper 175 and the distance between the wire gripper 184 and wire gripper 185 is reduced and the wire gripper pair 184, 185 is displaced slightly horizontally to grip the two wire ends 11, 12. Then the cable is transferred to the wire grippers 184, 185 and 174, 175 as both wire gripper pairs 174, 175; 184, 185 are closed and then the cable grippers of the twisting head and of the holding module 110 are opened.

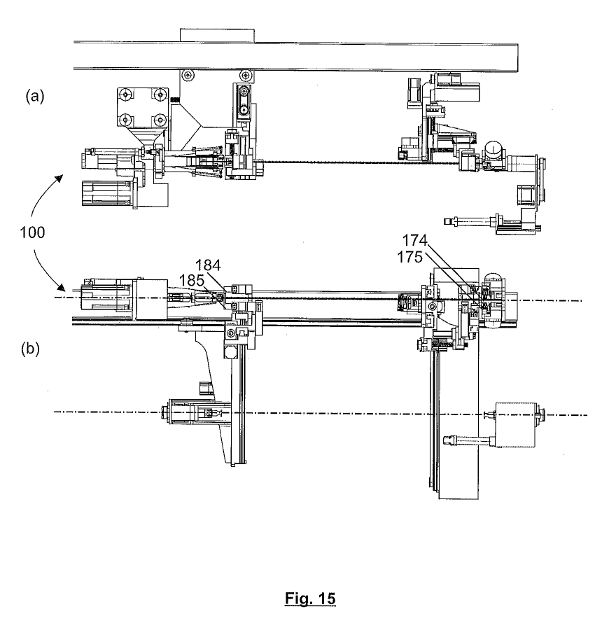

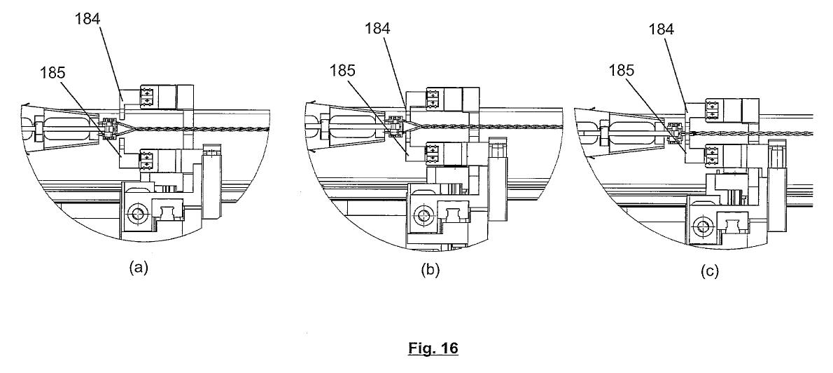

As shown in FIG. 15 after the transfer the wire ends 11, 12 are brought to the desired distance for the retwisting. For this purpose, the distance from the respective wire grippers 174 to 175 and from 184 to 185 is reduced further by further displacement of the respective linear axes.

FIG. 16 shows in (a)-(c) an enlarged inset of the wire grippers 184, 185 of the movable retwisting module 180, wherein (a) represents an enlargement of FIG. 13, (b) represents an enlargement of FIG. 14 and (c) represents an enlargement of FIG. 15. The wire grippers 184, 185 are in different positions in each of the insets (a)-(c) in FIG. 16.

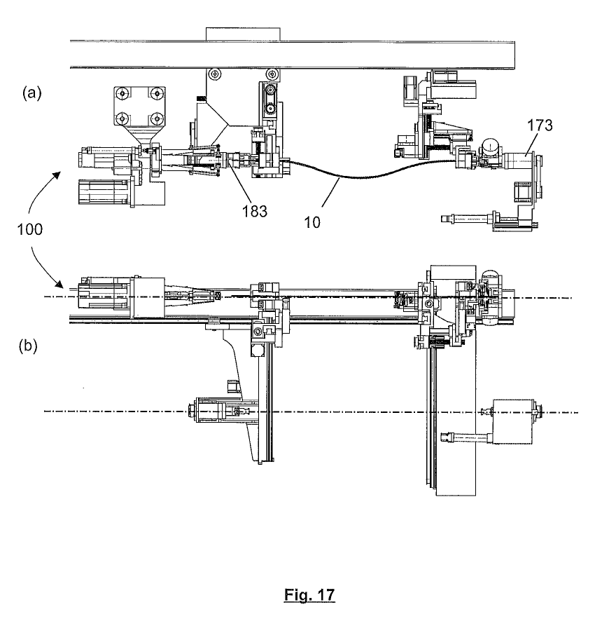

FIG. 17 shows the step that follows FIG. 15. In FIG. 17 the cable pair 10 is slackened in that the movable retwisting module 180 is moved towards the stationary retwisting module 170. The slackening of the cable pair 10 reduces the risk that the wire ends may slip out of the wire gripper 174, 175; 184, 185 or be shifted therein during the following movement of the cable pair 10.

Next, the two transfer units 172, 182 move the cable pair 10 to the retwisting axis N, wherein first a vertical movement is performed at the stationary retwisting module 170 so that it moves out of the area of the opened holding module 110. The two retwisting heads 173, 183 are then in an angular position which allows the cable pair 10 to be brought into the opened wire grippers 174, 175; 184, 185 of the retwisting heads 173, 183 without colliding.

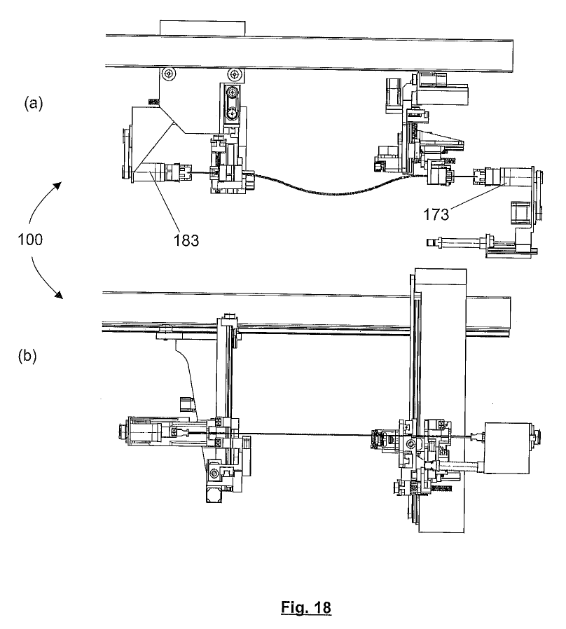

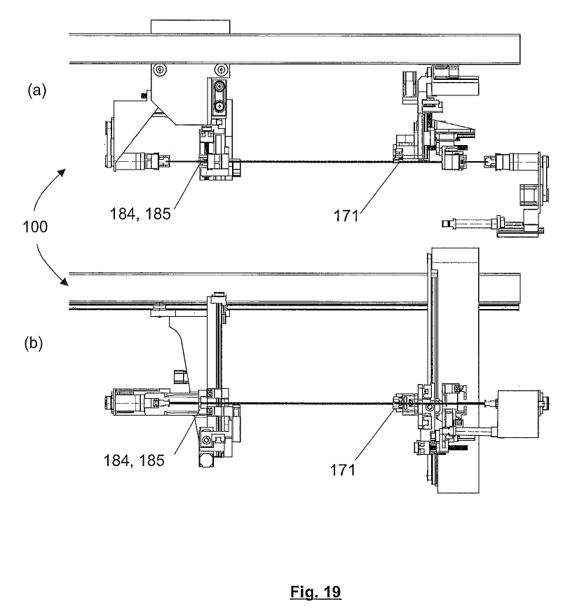

FIG. 18 shows the final position of the two transfer units. From this point on, the twisting head and the holding module are no longer represented in the figures.

Then, the cable pair 10 is prepared for the retwisting. For this, the cable pair 10 is stretched again and grasped by the retwisting heads 173, 183. Then, the wire grippers 174, 175; 184, 185 are opened.

Both ends of the cable pair 10 are fixed before the retwisting. On the stationary retwisting module 170, this is done by the fixing gripper 171. After a positional adjustment of the transfer unit 172 in the horizontal direction, the fixing gripper 171 is closed, so that the cable pair 10 is gripped. On the movable retwisting module 180, fixing is assured by one of the two wire grippers 184, 185, which is positioned correctly for clamping the entire cable pair 10 upon closing by a horizontal movement of the transfer unit 182.

FIG. 19 shows the situation immediately before the retwisting. The wire ends of the stretched cable pair 10 are held in the two retwisting heads 173, 183 and the cable pair 10 is fixed with the fixing gripper 171 and a wire gripper 184, 185.

A tensile force may be applied to the twisted wires 11, 12 as necessary.

The actual retwisting takes place by rotation of the retwisting heads 173, 183. For example, a machine controller (not shown) is provided, which calculates a number of revolutions for the retwisting heads 173, 183 from the known process parameters (lay length, external wire diameter etc.) and controls them accordingly.

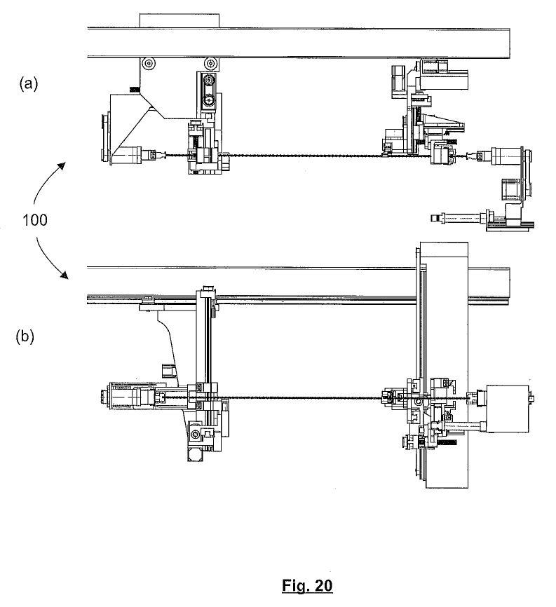

FIG. 20 shows the device with the finished cable pair 10 with the two cable ends 16, 17 having undergone retwisting.

The fixing may be released and the cable pair 10 may be dropped after the retwisting heads 173, 183 are opened, wherein the retwisting heads 173, 183 are first brought into the correct angular position. It is also conceivable to open the retwisting heads 173, 183 first and to pass the cable through the transfer units 172, 182 before it is deposited.

Although only a few embodiments of the present invention have been shown and described, it is to be understood that many changes and modifications may be made thereunto without departing from the spirit and scope of the invention.

What is claimed is:

1. An apparatus (100) for twisting first and second single electrical wires (11, 12) to form a cable pair (10), wherein the device (100) comprises a main twisting device (120) and a retwisting device (160) with an stationary retwisting module (170) and a retwisting module (180) that is movable along a linear guide direction;
wherein each of the retwisting modules (170, 180) comprises a transfer unit (172, 182) for transferring and holding an end of the twisted cable pair (10), wherein the transfer unit (172, 182) comprises a first wire gripper (174, 184) for the first single electrical wire (11) and a second wire gripper (175, 185) for the second single electrical wire (12), wherein a relative distance between the first wire gripper and the second wire gripper can be changed, typically changed programmably, according to a distance (a3) between the ends of the wires (11, 12); and
wherein at least one of the stationary retwisting module (170) and the movable retwisting module (180) is configured for retwisting of the respective held cable pair (10).

2. The apparatus according to claim 1, wherein the first wire gripper (174, 184) and/or the second wire gripper (175, 185) is configured to fix the respective held single electrical wire (11, 12).

3. The apparatus according to claim 1, wherein at least one of the stationary retwisting module (170) and the movable retwisting module (180) comprises a fixing device, typically a fixing gripper device (171, 181) which is configured to fix the respective held single electrical wire (11, 12).

4. The apparatus according to claim 1, wherein at least one of the stationary retwisting module (170) and the movable retwisting module (180) comprises a retwisting head (173, 183), wherein each retwisting head (173, 183) holds both single electrical wires (11, 12) of the twisted cable pair (10) and performs a predefined or predefinable, typically programmable number of revolutions for the retwisting.

5. The apparatus according to claim 4, wherein at least one of the retwisting heads (173, 183) is movable in the extension direction of the cable pair (10), typically movable under feedback-controlled force, so that a tensile force is exerted on the cable pair.

6. The apparatus according to claim 1, wherein the movable retwisting module (180) is embodied as a carriage which is provided on a linear guide (105) of the device and movable along the linear guide (105) in guided manner in the linear guide direction.

7. The apparatus according to claim 6, wherein the carriage is movable by means of a toothed belt drive.

8. The apparatus according to claim 1, wherein the movable retwisting module (180) further comprises a drive unit, typically a spindle drive, for moving a respective held end of the wires (11, 12) in the direction of the wire.

9. The apparatus according to claim 1, wherein the transfer unit (171, 181) further comprises a horizontal drive unit, typically a horizontal spindle drive, and a vertical drive unit, typically a vertical spindle drive, wherein the horizontal drive unit and the vertical drive unit are configured in such manner that they move at least one of the first and second wire grippers vertically and horizontally in a plane aligned at right angles to the cable axis.

10. A method for twisting first and second single electrical wires (11, 12) to form a cable pair (10) using the apparatus (100) according to claim 1, wherein the method comprises the following:
twisting the single electrical wires (11, 12) with the main twisting module (120) to obtain a twisted cable pair (10);
moving the wire grippers (174, 175; 184, 185) of the transfer module (172, 182) to a position corresponding to an associated single electrical wire (11, 12) of the twisted cable pair (10);
transferring the single electrical wires (11, 12) to the respectively associated wire grippers (174, 175; 184, 185);
reducing the distance between the wire grippers (174, 175; 184, 185);
bringing the twisted cable pair (10) to a retwisting position;
transferring the twisted cable pair to the retwisting heads (173, 183) of the retwisting modules (170, 180); and
performing retwisting of the twisted cable pair (10).

11. The method according to claim 10, wherein during the retwisting the twisted cable pair (10) is fixed by one of the wire grippers (174, 175; 184, 185) or by a fixing gripper (171, 181).

12. The method according to claim 10, further comprising:
before bringing the twisted cable pair (10) to the retwisting position: moving the movable retwisting module (180) towards the stationary retwisting module (170).

13. The method according to claim 10 further comprising:
before the retwisting of the twisted cable pair (10) and during the retwisting: exerting a tensile force on the cable pair (10) that is to be twisted.
